(19) United States
(12) Patent Application Publication
(10) Pub. No.: US 2018/0130144 A1
(43) Pub. Date: May 10, 2018

(54) GAS FACILITY OPERATION MANAGEMENT SYSTEM

(71) Applicant: Nippon Gas Co., LTD., Tokyo (JP)

(72) Inventors: Shinji Wada, Tokyo (JP); Shingo Dekamo, Tokyo (JP)

(21) Appl. No.: 15/569,715

(22) PCT Filed: Mar. 14, 2016
(86) PCT No.: PCT/JP2016/001450

§ 371 Date: Oct. 26, 2017

(30) Foreign Application Priority Data
May 21, 2015 (JP) 2015-103833

(51) Int. Cl. G06Q 50/06; G06Q 10/10

(52) U.S. Cl. CPC G06Q 50/06; G06F 3/0482; G06Q 10/1097

(57) ABSTRACT

A method comprises causing a display unit of a client computer to perform presentation and generating an interface screen for accepting, from a user, a request message including an operator identification and a designated year and month, the interface screen including a first screen on which a date corresponding to the designated year and month is displayed in a calendar form, and a second screen on which the gas facility operation data is displayed; receiving a request message from the client computer; acquiring, from a data storage unit, gas facility operation data indicating that the state is uncompleted, on the basis of the designated year and month and the operator identification; calculating a number of the gas facility operation data for each date corresponding to the designated year and month; displaying the number of gas facility operation data on the first screen; and displaying the gas facility operation data.

### TECHNICAL FIELD

The present invention relates to a gas facility operation management system, and in particular to a gas facility operation management system that manages a state of a gas facility operation associated with opening cock of gas.

### BACKGROUND ART

Generally, the types of gas supplied to houses or the like are classified into the so-called “city gas” and liquefied natural gas (LP gas: liquefied petroleum gas). City gas is supplied through underground gas pipelines to thereby be subsequently used in a house or the like via a gas meter. On the other hand, LP gas is used in a manner such as delivering, to the customer's house, a gas cylinder having LP gas encapsulated therein to be subsequently used in the house or the like via a gas meter.

In supplying LP gas, a gas facility from the gas cylinder to the exit of the gas meter is referred to as a “gas supply facility”, which is regulated by law to be checked and maintained under the responsibility of the gas supplier. This means that there may be generated checking/construction or the like by operators of the gas supplier in a case of replacing a gas cylinder or the like due to aging, or newly installing a gas cylinder or the like due to change of residence or the like.

Infrastructure such as gas, which is one of the most important elements for residents, is desired to avoid becoming unusable even for a single day. Accordingly, the gas supplier is not allowed to forget the schedule of the aforementioned construction or the like, and the operators are required to strictly manage an operation schedule or the like at respective gas supply destinations.

### CITATION LIST

### Patent Literature

PTL 1: Japanese Patent Laid-Open No. 2004-295286

### SUMMARY OF INVENTION

As disclosed in PTL 1, in a case where any one of the operations of checking, replacing, and repairing equipment associated with a house gas facility has been undertaken, there is a gas facility construction management system that manages the progress of each operation by data processing in a computer. According to the system described in PTL 1, it becomes possible to manage the operation progress by accepting the type of the undertaken operation and the house attribute data, and by managing the process of operation.

However, the system described in PTL 1 only manages the progress of each operation up to completion of the operation. With such a system, it becomes difficult to manage the progress of operations as the number of operations to be performed by an operator increases. Additionally, in a case where priority is set among a plurality of operations to be performed by an operator, although management is required in consideration of the priority, the system according to PTL 1 does not meet such a requirement.

The present invention has been made in view of such a problem and aims to provide a gas facility operation management system which allows an operator of a gas supplier to manage, on a monthly or daily basis, the number of not-yet handled operations, the number of operations required to be urgently handled, and/or the number of overdue operations of gas facility operations to be performed by the operator himself or herself.

In order to solve the aforementioned problem, the gas facility operation management system according to the present invention, which is a computer system connected to a client computer, the computer system including: a data storage unit storing gas facility operation data including an acceptance type, a state, a scheduled corresponding date, and an operator identification, for a gas facility operation; a display unit causing a display unit of the client computer to perform display, and generating an interface screen for accepting, from a user, a request message including an operator identification and a designated year and month, the interface screen including a first screen on which a date corresponding to the designated year and month is displayed in a calendar form, and a second screen on which the gas facility operation data is displayed; a request message receiving unit receiving, from the client computer, a request message having been input from the interface screen; a gas facility operation data acquisition unit acquiring, from the data storage unit, gas facility operation data indicating that the state is uncompleted, on the basis of the designated year and month and the operator identification; a number-of-gas-facility-operation-data calculating unit calculating the number of the acquired gas facility operation data records for each date corresponding to the designated year and month; a number-of-gas-facility-operation-data display unit displaying the calculated number of gas facility operation data on the first screen; and a gas facility operation data display unit displaying the acquired gas facility operation data on the second screen.

The gas facility operation management system according to the present invention displays, on the mobile model terminal carried by a gas operator, the gas facility operation state for each operation progress state of a gas facility operation on a monthly or daily basis, thereby allowing the gas operator to more strictly manage the gas facility operation.

### BRIEF DESCRIPTION OF DRAWINGS

FIG. 1 is a view illustrating an exemplary configuration of the entire computer system constituting a gas facility operation management system according to an embodiment of the present invention;

FIG. 2 is a diagram illustrating an exemplary detailed configuration of a computing device constituting the gas facility operation management system according to an embodiment of the present invention;

FIG. 3 is a diagram illustrating an exemplary gas facility operation display/interface screen according to an embodiment of the present invention;

FIG. 4 is a diagram illustrating an exemplary gas facility operation data table according to an embodiment of the present invention;

FIG. 5 is a diagram illustrating an exemplary gas supply destination data table according to an embodiment of the present invention;

FIG. 6 is a diagram illustrating an exemplary employee data table according to an embodiment of the present invention;

FIG. 7 is a diagram illustrating an exemplary gas facility operation display interface according to an embodiment of the present invention;

FIG. 8 is a flowchart illustrating an exemplary gas facility operation data display processing according to an embodiment of the present invention;

FIG. 9A is a diagram illustrating an exemplary gas facility operation update interface according to an embodiment of the present invention; and

FIG. 9B is a diagram illustrating an exemplary gas facility operation update interface according to an embodiment of the present invention.

### DESCRIPTION OF EMBODIMENTS

### Definitions of Terms

Hereinafter, a gas facility operation management system according to an embodiment of the present invention will be described in detail with reference to the accompanying drawings. In the present Description, a business operator engaged in supplying gas is referred to as a “gas supplier”; a customer and/or demander receiving gas supply is referred to as a “gas supply destination”; a person who performs a checking/replacement operation or the like at a gas supply destination under the management of a gas supplier is referred to as an “operator”, respectively. An operator belongs to a gas supplier or a business entity in contract with a gas supplier, and is managed by any of the offices of the gas supplier (therefore, a company identification and an office identification of the gas supply company are assigned to the operator). In addition, a gas facility from a gas cylinder to an exit of a gas meter, including the gas cylinder and the gas meter of LP gas, is referred to as a “gas supply facility”, and gas equipment including a gas stove, a gas fan heater, or the like is referred to a “gas consumption facility”, and the gas supply facility and the gas consumption facility are collectively referred to a “gas facility”. Furthermore, an operation of a gas facility such as newly opening cock of gas, replacement of a gas cylinder, to be performed by an operator at a house of the gas supply destination or the like is referred to as a “gas facility operation”.

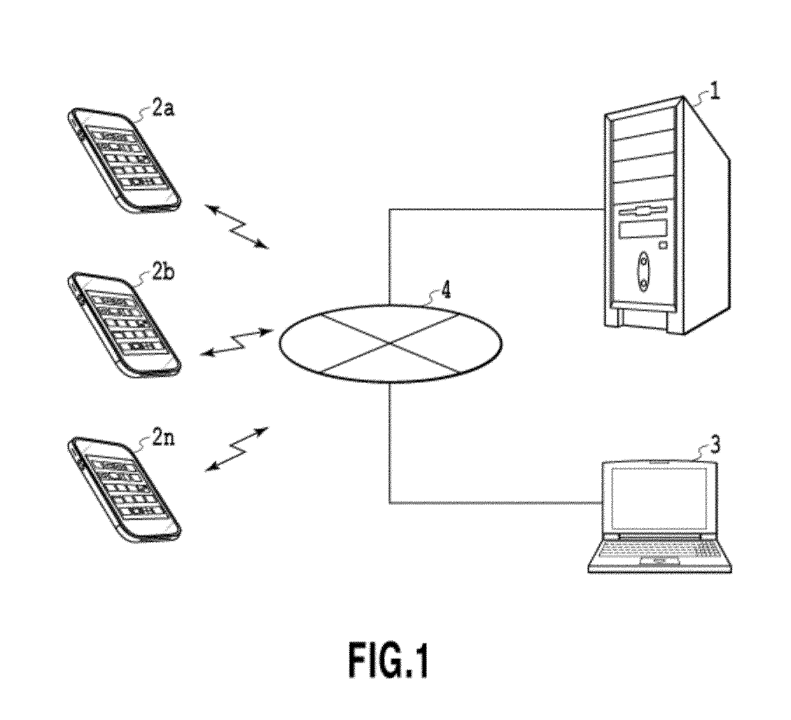

FIG. 1 illustrates an exemplary configuration of the entire computer system realizing the gas facility operation management system according to an embodiment of the present invention.

The gas facility operation management system according to the present embodiment includes a gas facility operation management server 1, mobile terminals (such as mobile phones) 2a, 2b, . . . 2n (hereafter, “mobile terminal 2”), and an information input terminal 3, all of which are connected to each other via a network 4.

The gas facility operation management server 1 is a server computing device which is managed by a gas supplier and which performs major functions of the gas facility operation management system according to the present invention. The gas facility operation management server 1 accepts an input of information relating to a gas facility operation from the information input terminal 3, and registers and manages the accepted information. The gas facility operation management server 1 may be implemented by a single computing device, or may be implemented by a plurality of computing devices.

The mobile terminal 2 is carried by an operator, and is a client computing device used for managing the gas facility operation performed by the operator. The operator inputs, to the mobile terminal 2, an update value for a state of the gas facility operation to be perform by the operator (the input information is transmitted to the gas facility operation management server 1, and the updated information is managed in the gas facility operation management server 1). In the present embodiment, although the mobile terminal 2 is assumed to be a mobile phone represented by a smartphone, it is not limited to such a device, and as long as the device is a computing device having an image display function and a communication function, the device is not particularly limited.

The information input terminal 3, being used by a person-in-charge or the like of an office of a gas supplier (hereafter, “person-in-charge”), is a computing device for inputting information relating to a gas facility operation. The person-in-charge of the gas supplier inputs information of the gas supply destination or the like via the information input terminal 3 in a case of accepting a request such as gas opening cock from a gas supply destination. In the present embodiment, although the information input terminal 3 is assumed to be an information terminal such as a personal computer, it is not limited to such a device and any computing device having an image display function and a communication function may be used without limitation.

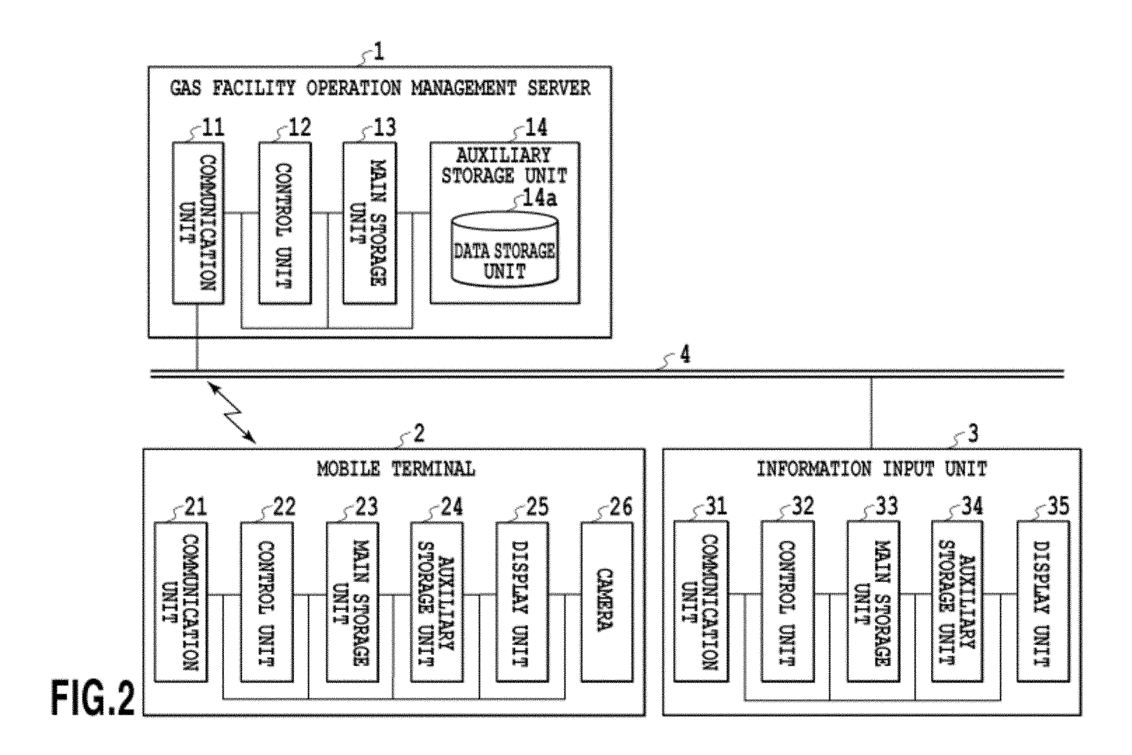

Next, an exemplary detailed configuration of a computing device included in a call center system according to an embodiment of the present invention will be described with reference to FIG. 2.

The gas facility operation management server 1 includes a communication unit 11, a control unit 12, a main storage unit 13, and an auxiliary storage unit 14, all of which are connected to each other via a system bus.

The communication unit 11 transmits and receives data to and from the mobile terminal 2 and the information input terminal 3 which are connected to each other via the network 4. Transmission and reception of data to and from the mobile terminal 2 may be performed in the form of CDMA (code division multiple access), TDMA (time division multiple access), FDMA (frequency division multiple access), or OFDMA (orthogonal frequency division multiple access), or the like.

The control unit 12, also referred to as a processor has a controller which controls the gas facility operation management server 1 as a whole, an arithmetic unit, an interface with the main storage unit 13, and an interface with an input-output device of a peripheral device. The control unit 12 performs control of the respective components described above, data arithmetic processing and the like, and also reads various programs stored in the auxiliary storage unit 14 to the main storage unit 13, and executes the same.

The main storage unit 13, also referred to as a main memory or a temporary storage device, is a storage device directly accessible from the control unit 12. The control unit 12 reads and executes an instruction stored in the main storage unit 13. In addition, data being frequently operated by the control unit 12 is stored in the main storage unit 13 in a similar manner.

The auxiliary storage unit 14 is a storage device represented by an HDD (hard disk drive) or the like, and has a data storage unit (database table) 14a storing a gas supply destination data table or the like described later. In addition, the auxiliary storage unit 14 stores therein programs (not illustrated) for causing the control unit 12 to execute various processing according to the present embodiment. Note that the gas facility operation management server 1 implements a DBMS (database management system) (not illustrated), and executes reading, insertion, updating, or the like of data records from the gas supply destination data table or the like, by execution of the DBMS by the control unit 12.

The mobile terminal 2 includes a communication unit 21, a control unit 22, a main storage unit 23, an auxiliary storage unit 24, a display unit 25, and a camera 26, all of which are connected to each other via a system bus.

The communication unit 21 receives gas facility operation data described later from the gas facility operation management server 1 via the network 4. In addition, the communication unit 21 transmits gas facility operation data updated by the operator to the gas facility operation management server 1 via the network 4.

The control unit 22 is a central processing unit, reads a gas facility operation display/update program stored in the auxiliary storage unit 24 out to the main storage unit 23, executes the program, and executes control of respective components described above, data arithmetic processing, and the like.

The main storage unit 23 is the main memory, and stores therein input data received by the mobile terminal 2, computer-executable instructions, data after arithmetic processing by the instructions, or the like.

The auxiliary storage unit 24 is a storage device such as a hard disk, and stores therein the gas facility operation display/update program described above. Note that the gas facility operation display/update program may be preliminarily stored in the auxiliary storage unit 24, or may be downloaded from the gas facility operation management server 1.

The display unit 25 is a display caused to display, by execution of the gas facility operation display/update program by the control unit 22, a gas facility operation display/update interface for the operator to update the gas facility operation data. The display unit 25 may include, for example, a touch panel display which detects input operations such as a touch operation, a flick operation, and a slide operation, all of which are performed by the operator, through the utilization of a technique such as a resistance film method or an electrostatic capacitance method.

The camera 26 captures an image of a two-dimensional bar code (QR code (quick response code: registered trademark), etc.) attached to a gas cylinder and/or a gas meter installed in a house of the gas supply destination or the like. The two-dimensional bar code sets thereon a code identifying the gas supply destination, and a target gas supply destination is identified by the control unit 22 recognizing the image-captured two-dimensional bar code. Although the resolution of the camera 26 is not limited in particular, at least a resolution capable of almost reading the aforementioned two-dimensional bar code is required.

The information input terminal 3 includes a communication unit 31, a control unit 32, a main storage unit 33, an auxiliary storage unit 34, and a display unit 35, all of which are connected to each other via a system bus.

The communication unit 31 transmits, to the gas facility operation management server 1 via the network 4, the gas facility operation data or the like which has been input by the person-in-charge of the gas supplier.

The control unit 32 is a central processing unit, reads a gas facility operation display/input program stored in the auxiliary storage unit 34 to the main storage unit 33, executes the program, and executes control of respective components described above, data arithmetic processing, and the like.

The main storage unit 33 is the main memory, and stores therein input data received by the information input terminal 3, computer-executable instructions, and data after arithmetic processing by the instructions, or the like.

The auxiliary storage unit 34 is a storage device such as a hard disk, and stores therein the gas facility operation display/input program described above. Note that the gas facility operation display/input program may be preliminarily stored in the auxiliary storage unit 34, or may be downloaded from the gas facility operation management server 1.

The display unit 35 is a display caused to display, by execution of the gas facility operation display/input program by the control unit 32, a gas facility operation display/interface screen for the person-in-charge of the gas supplier to input the gas facility operation data.

<Gas Facility Operation Data Registration Processing>

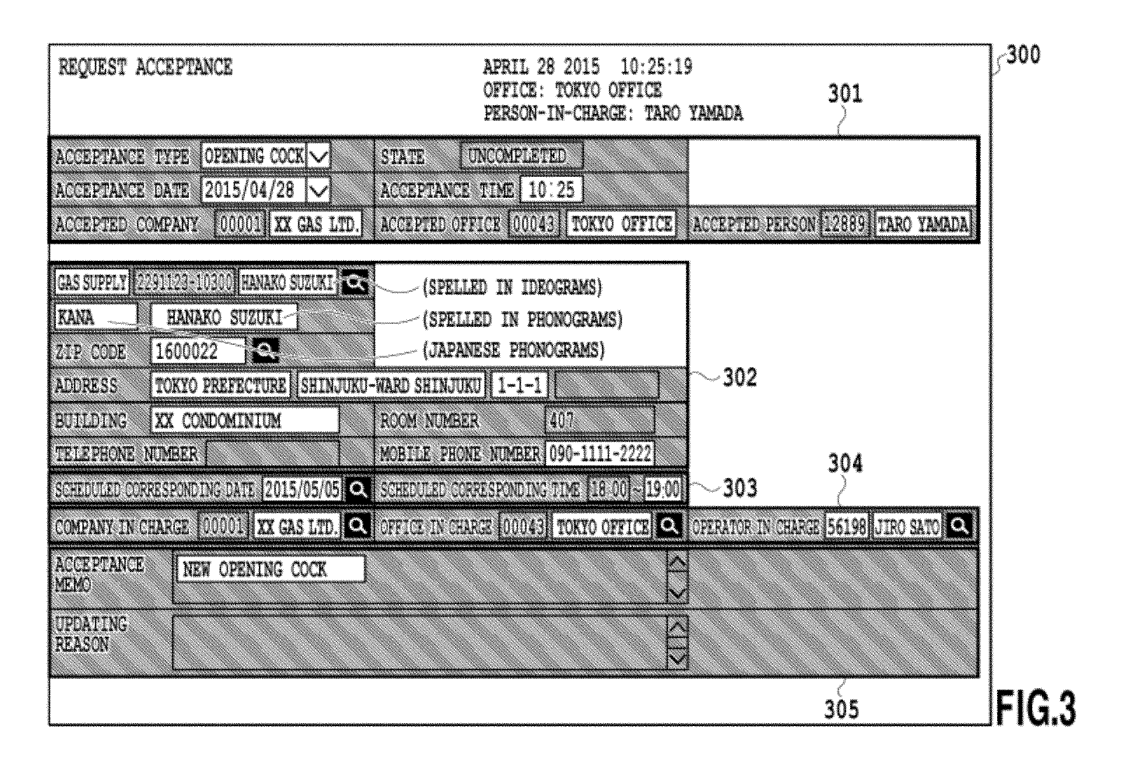

Next, a gas facility operation display/interface screen 300 will be described with reference to FIG. 3. The gas facility operation display/interface screen 300 is an interface screen which is displayed on the display unit 35 of the information input terminal 3 and which allows the person-in-charge of the gas supplier to input information of the gas supply destination or the like in accepting a request such as gas opening cock from a gas supply destination. One event for the gas facility operation is registered from the gas facility operation display/interface screen 300.

The gas facility operation display/interface screen 300 is generated by execution of a predetermined program by the control unit 12 of the gas facility operation management server 1, and is displayed (in the form of a WEB browser) by transmission of data of the interface screen to the information input terminal 3. Alternatively, the gas facility operation display/interface screen 300 may be displayed by execution of the gas facility operation display/input program stored in the auxiliary storage unit 34 by the control unit 32 of the information input terminal 3.

The gas facility operation display/interface screen 300 has an acceptance information input field 301, a gas supply destination information input field 302, a scheduled corresponding date input field 303, an operator-in-charge information input field 304, and an acceptance memo/updating reason input field 305.

The acceptance information input field 301 is an input field for inputting: type of a gas facility operation (hereafter, “acceptance type”); state (“uncompleted”, “completed”, etc.); date and time of acceptance of a request for a gas facility operation; information of the person-in-charge who has accepted (input) the request (identification of the person-in-charge of the gas supplier, organization (office, etc.) to which the person-in-charge belongs), etc.); or the like. Note that, in a case of inputting information of the person-in-charge, an employee data record may be acquired by input of a person-in-charge identification, from an employee data table 600 described later, on the basis of the identification. The acquired employee data record is displayed on the acceptance information input field 301.

The acceptance type is defined as illustrated in Table 1, and these types are selectable in a form of a list box or the like. Note that the acceptance types illustrated in Table 1 are only exemplary, and are not limited to these illustrated items.

TABLE 1
acceptance type list

| Acceptance Type | Details |
|---|---|
| opening cock | new opening cock of gas |
| closing cock | closing cock of gas due to |
| | safety construction, or the |
| | like |
| upgrading (downgrading) | change in gas supply method |
| | change |
| calorific value change | change in gas supply calorific |
| | value |
| cancellation | cancellation of supply |
| | contract |
| new installation | new acceptance of gas supply |
| | contract |
| new switching | acceptance of gas supply |
| | contract due to switching |
| bill collection | bill collection of gas charge |
| notification | |
| claim | |
| inquiry | inquiry about failure, or the |
| | like |
| periodic inspection | periodic inspection of gas |
| | supply facility, or the like |
| gas supply facility | gas supply facility |
| replacement | replacement due to aging, or |
| | the like |
| urgently accepted | urgent corresponding |
| | required, such as failure of |
| | gas supply facility |

The gas supply destination information input field 302 is an input field for inputting information such as full name and address of the gas supply destination (hereafter, “gas supply destination data”). In a case where gas supply destination data is already registered in the gas facility operation management server 1, a gas supply destination data record is acquired, by inputting a gas supply destination identification, from a gas supply destination data table 500 described later, on the basis of the identification. The acquired gas supply destination data record is displayed on the gas supply destination information input field 302. On the other hand, in a case where the gas supply destination data is not registered in the gas facility operation management server 1, the gas supply destination data is registered in the gas supply destination data table 500 by newly inputting the gas supply destination data to the gas supply destination information input field 302, and a gas supply destination identification is assigned thereto.

The scheduled corresponding date input field 303 is an input field for inputting the scheduled operation date and time of the gas facility operation accepted through the gas facility operation display/interface screen 300. Although details will be described later, the gas facility operation is managed according to the scheduled operation date and time having been input in the scheduled corresponding date input field 303.

The operator-in-charge information input field 304 is an input field for inputting information of the operator in charge of the gas facility operation (identification of an operator of a gas supplier or a business operator in contract with a gas supplier, organization (office, or the like) to which the operator belongs, and the like). Note that, with regard to the operator-in-charge information input field 304, an employee data record may be acquired, by inputting an operator identification, from the employee data table 600 described later, on the basis of the identification. The acquired employee data record is displayed on operator-in-charge information input field 304.

The acceptance memo/updating reason input field 305 is an input field for inputting special remarks in accepting a request for a gas facility operation and for inputting the updating reason in changing the process of the gas facility operation (for example, in a case of first visiting a house of the gas supply destination after accepting a request for gas opening cock).

In a case where gas facility operation data is input to the gas facility operation display/interface screen 300, the communication unit 31 of the information input terminal 3 transmits the input gas facility operation data to the gas facility operation management server 1. The transmitted gas facility operation data is added to the gas facility operation data table of the data storage unit 14a, in the gas facility operation management server 1.

Note that, in the present embodiment, although the gas facility operation data is to be input from the information input terminal 3 by the person-in-charge of the gas supplier, the data may be input from the mobile terminal 2 of the gas supplier (namely, by the operator). In addition, with regard to the information of the gas supply destination, in a case where, for example, the operator visits the house of the gas supply destination, the gas supply destination identification may be specified by photographing of a two-dimensional bar code attached to a gas cylinder or a gas meter installed at the gas supply destination, by the operator using the camera 26 of the mobile terminal 2.

In a case of accepting a request for a gas facility operation, information associated with the content of the acceptance type together with the aforementioned gas facility operation data (for example, in a case where the acceptance type is “calorific value change”, it is necessary to input information such as calorific value of gas being supplied to the gas supply destination, and scale number of gas meter installed) is displayed on and input onto the gas facility operation input/display interface 300, and the pieces of information will be registered in the gas facility operation management server 1, but description as to details of the pieces of information will be omitted.

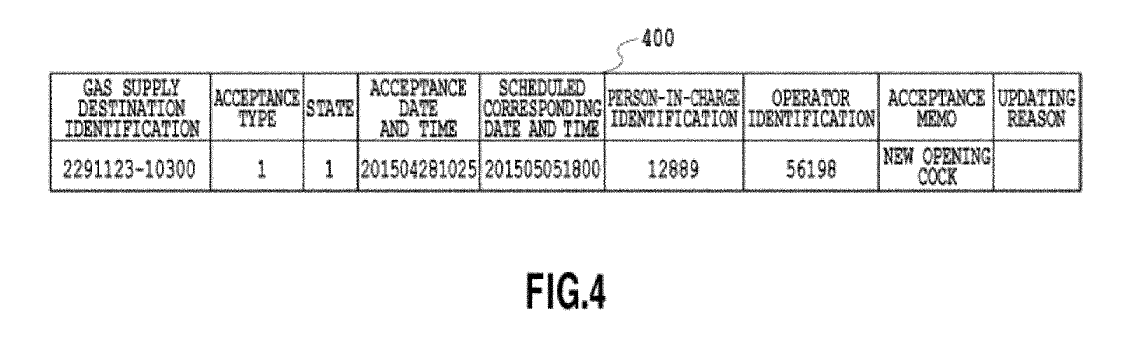

FIG. 4 is a diagram illustrating a gas facility operation data table 400. The gas facility operation data table 400 is a database table stored in the data storage unit 14a of the gas facility operation management server 1. The gas facility operation data table 400 has items of: “gas supply destination identification”, “acceptance type”, “state”, “acceptance date and time”, “scheduled corresponding date and time”, “person-in-charge identification”, and “operator identification”. A value having been input from the gas facility operation display/interface screen 300 described in FIG. 3 is set to each item.

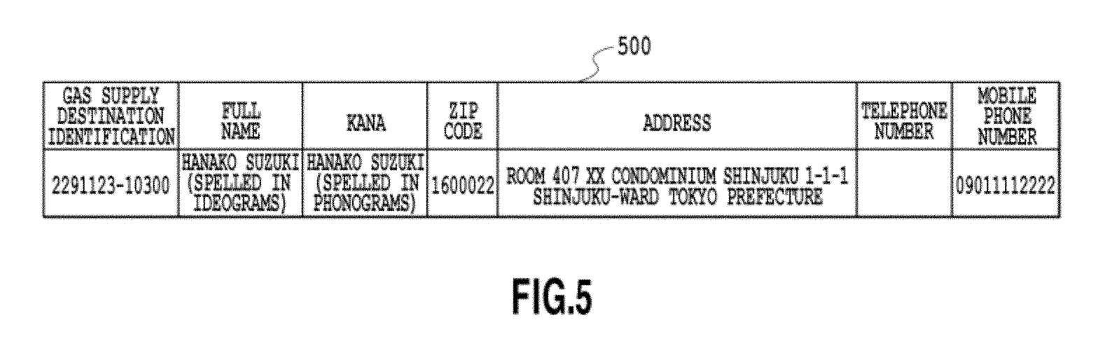

FIG. 5 is a diagram illustrating the gas supply destination data table 500. The gas supply destination data table 500 is a database table stored in the data storage unit 14a of the gas facility operation management server 1. The gas supply destination data table 500 has items of: “gas supply destination identification”, “full name”, “kana (Japanese phonograms)”, “zip code”, “address”, “telephone number”, and “mobile phone number”. A value having been input from the gas facility operation display/interface screen 300 described in FIG. 3 is set to each item.

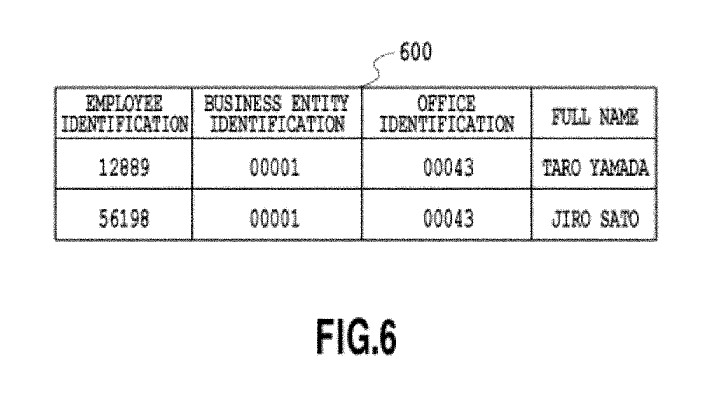

FIG. 6 is a diagram illustrating the employee data table 600. The employee data table 600 is a database table stored in the data storage unit 14a of the gas facility operation management server 1. The employee data table 600 has items of: “employee identification”, “business operator identification”, “office identification”, and “full name”. A value having been input from the gas facility operation display/interface screen 300 described in FIG. 3 is set to each item.

<Gas Facility Operation Data Display Processing>

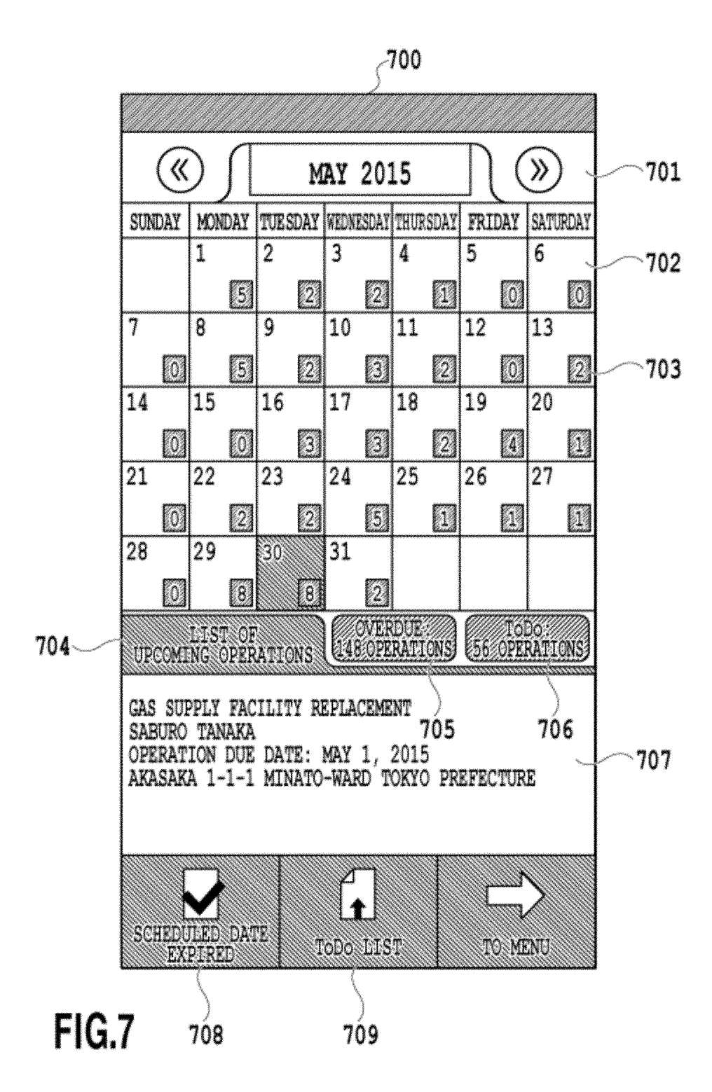

Next, a gas facility operation display interface 700 will be described with reference to FIG. 7. The gas facility operation display interface 700 is a display interface which is displayed on the display unit 25 of the mobile terminal 2, and which allows the operator to manage the scheduled operation date or the like of the gas facility operation to be performed by the operator.

The gas facility operation display interface 700 is generated by execution of the control unit 12 of the gas facility operation management server 1, and is displayed (in the form of a WEB browser) by transmission of data of the interface screen to the mobile terminal 2. Alternatively, the gas facility operation display interface 700 may be generated by performing, by the control unit 12 of the mobile terminal 2, a gas facility operation display/update program stored in the auxiliary storage unit 24.

As illustrated in FIG. 7, the gas facility operation display interface 700 has a year-and-month designation field 701, a date display field 702, a number-of-daily-operations display field 703, a list-of-upcoming-operations display button 704, a number-of-overdue-operations display field 705, a number-of-scheduled-operations display field 706, a list-of-operations display field 707, a list-of-overdue-operations display button 708, and a list-of-scheduled-operations display button 709. The gas facility operation display interface 700 receives a target record from the gas facility operation data table 400 of the gas facility operation management server 1 on the basis of conditions designated (input) by the operator, and displays the data.

The year-and-month designation field 701 is an input field for designating the year and month to be displayed on the date display field 702. As illustrated in FIG. 7, a date of a year and month designated in the year-and-month designation field 701 is displayed on the date display field 702 in a calendar form. Note that, in an initial state, the year and month of the system date in displaying the gas facility operation display interface 700 is designated.

The number-of-daily-operations display field 703 has the number of gas facility operation data whose states are “uncompleted” as of the year and month designated in the year-and-month designation field 701, displayed on the date display field 702 for each day. In addition, in a case where a touch operation and/or a flick operation, or the like (hereafter, “input operation”) are/is performed on each date on the date display field 702, there is displayed in a list form the gas facility operation data with the specified date being the scheduled operation date, in the list-of-operations display field 707.

The aforementioned gas facility operation data whose state is “uncompleted” is acquired from the gas facility operation data table 400 by determination of data records with values of the item “state” being “uncompleted”.

The list-of-upcoming-operations display button 704 is a button for displaying data with the closest operation, among the gas facility operation data whose state is “uncompleted”. In a case where an input operation is performed on the list-of-upcoming-operations display button 704, there is displayed in a list form the gas facility operation data with the closest scheduled operation date (alternatively, a predetermined number of gas facility operation data with the closest scheduled operation date), in the list-of-operations display field 707.

The aforementioned gas facility operation data with the closest scheduled operation date is acquired from the gas facility operation data table 400 by determination of the data record with the value of the item “state” being “uncompleted” and the value of the “scheduled operation date and time” being closest to the system date.

The number-of-overdue-operations display field 705 has the number of gas facility operation data whose state is “uncompleted” and scheduled operation date is already overdue, displayed thereon. Display of the number of overdue operations may be such that only the number of the gas facility operation data (monthly number of overdue operations) whose scheduled operation date of the year and month designated in the year-and-month designation field 701 is already overdue is displayed (in the example of FIG. 6, the number of overdue operations with the scheduled operation date being May 2015 is displayed, whereas designation of April 2015 in the year-and-month designation field 701 causes the number of overdue operations with the scheduled operation date being April 2015, to be displayed). In addition, the total number of gas facility operation data whose scheduled operation date is already overdue may be displayed.

The gas facility operation data whose scheduled operation date is overdue is acquired from the gas facility operation data table 400 by determination of the data record with the value of the item “state” being “uncompleted” and the value of “scheduled operation date and time” being equal to or earlier than the system date.

The number-of-scheduled-operations display field 706 has the number of gas facility operation data records whose state is “uncompleted” and scheduled operation date is not overdue, displayed thereon. Display of the number of scheduled operations may be such that only the number (monthly number of scheduled operations) of the gas facility operation data with the year and month designated in the year-and-month designation field 701 being the scheduled operation date is displayed (in the example of FIG. 6, the number of scheduled operations with May 2015 being the scheduled operation date is displayed, whereas designation of April 2015 in the year-and-month designation field 701 causes the number of operations with April 2015 being the scheduled operation date, to be displayed). In addition, the total number of gas facility operation data whose state is “uncompleted” may be displayed.

The list-of-overdue-operations display button 708 is a button for displaying gas facility operation data whose state is “uncompleted” and scheduled operation date is already overdue. In a case where an input operation is performed on the list-of-overdue-operations display button 708, there is displayed in a list form the gas facility operation data whose scheduled operation date is already overdue, in the list-of-operations display field 707. Display of the list of overdue operations may be such that only the gas facility operation data (monthly list of overdue operations) whose scheduled operation date of the year and month designated in the year-and-month designation field 701 is already overdue is displayed (in the example of FIG. 6, a list of overdue operations with May 2015 being the scheduled operation date is displayed, whereas designation of April 2015 in the year-and-month designation field 701 causes a list of overdue operations with April 2015 being the scheduled operation date, to be displayed). In addition, all of the gas facility operation data whose scheduled operation date is already overdue may be displayed.

The list-of-scheduled-operations display button 709 is a button for displaying gas facility operation data whose state is “uncompleted” and scheduled operation date is not overdue. In a case where an input operation is performed on the list-of-scheduled-operations display button 709, there is displayed in a list form the gas facility operation data whose state is “uncompleted” and scheduled operation date is not overdue, in the list-of-operations display field 707. Display of the scheduled operations list may be such that only the gas facility operation data (monthly list of scheduled operations) with the year and month designated in the year-and-month designation field 701 being the scheduled operation date (in the example of FIG. 6, a list of operations with the scheduled operation date being May 2015 is displayed, whereas designation of April 2015 in the year-and-month designation field 701 causes a list of operations with April 2015 being the scheduled operation date, to be displayed). In addition, all of the gas facility operation data whose state is “uncompleted” may be displayed.

Except for the above description, the number and a list of gas facility operation data whose acceptance type is “urgently accepted” and state is “uncompleted” may be displayed. In a case of performing such display, it is possible to provide a number-of-urgently-accepted-operations display field and an list-of-urgently-accepted-operations display button (not illustrated) on the gas facility operation display interface 700, and to display, by performing an input operation thereon, the number and a list of urgently accepted gas facility operations (namely, gas facility operations of higher priority than usual).

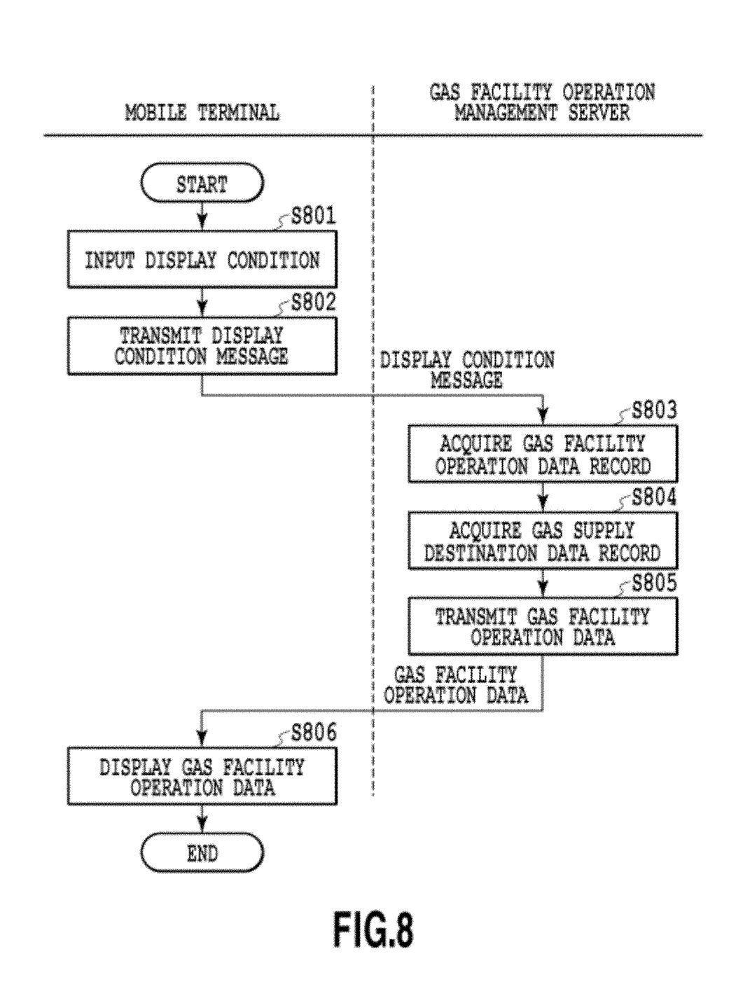

Next, an operation of the aforementioned gas facility operation data display processing will be described with reference to the flowchart of FIG. 8.

First, a display condition is input by the operator, on the gas facility operation display interface 700 displayed on the display unit 25 of the mobile terminal 2 (step S801). Here, the display condition is an indicator or the like indicating the year and month designated in the year-and-month designation field 701 and the list-of-upcoming-operations display button 704 described in FIG. 6 has been input (namely, a condition for displaying gas facility operations). In a case where a display condition is input, the communication unit 21 transmits the input display condition to the gas facility operation management server 1 as a display condition message (step S802).

In a case where the communication unit 11 of the gas facility operation management server 1 receives the display condition message, the control unit 12 acquires a relevant record from the gas facility operation data table 400 on the basis of the condition described in the display condition message (step S803). Here, the display condition message includes an operator identification, and, on the basis of the operator identification, a relevant gas facility operation data record is acquired from the gas facility operation data table 400.

The display condition message includes, besides the foregoing, data indicating an input operation on the input fields, buttons and the like described in FIG. 7, and gas facility operation data records are acquired as illustrated in Table 2.

TABLE 2
acquisition method of gas facility operation data
records according to value of display condition message

| input operation | record acquisition |
|---|---|
| input operation performed on | acquire records with item |
| year-and-month designation | “state” of gas facility |
| field 701 | operation data table 400 being |
| | “uncompleted” and value of |
| | “scheduled corresponding |
| | starting date and time” being |
| | year and month designated in |
| | year-and-month designation |
| | field 701 |
| input operation performed on | acquire records with item |
| date display field 702 | “state” of gas facility |
| | operation data table 400 being |
| | “uncompleted” and value of |
| | “scheduled corresponding |
| | starting date and time” being |
| | year/month/day displayed in date |
| | display field |
| input operation performed on | acquire records with item |
| list-of-upcoming-operations | “state” of gas facility |
| display button 704 | operation data table 400 being |
| | “uncompleted” and value of |
| | “scheduled corresponding |
| | starting date and time” being |
| | closest to system date, or |
| | acquire a predetermined number |
| | of records close to system date |
| input operation performed on | acquire records with item |
| number-of-overdue-operations | “state” of gas facility |
| display field 705 | operation data table 400 being |
| | “uncompleted” and value of |
| | “scheduled corresponding |
| | starting date and time” being |
| | earlier than system date |
| input operation performed on | acquire records with item |
| number-of-scheduled-operations | “state” of gas facility |
| display field 706 | operation data table 400 being |
| | “uncompleted” |
| input operation performed on | acquire records with item |
| list-of-urgently-accepted- | “state” of gas facility |
| operations display button | operation data table 400 being |
| (not illustrated) | “uncompleted” and “acceptance |
| | type” being “urgently accepted” |

Note that the display condition message may include a person-in-charge identification (in a case where the person-in-charge operates the gas facility operation display interface 700 and refers to a gas facility operation) and, in such a case, a relevant gas facility operation data record is acquired from the gas facility operation data table 400, on the basis of the person-in-charge identification.

Next, the control unit 12 acquires, on the basis of the item “gas supply destination identification” included in the gas facility operation data record acquired in step S803, a relevant record from the gas supply destination data table 500 (step S804). Here, acquisition of the record from the gas supply destination data table 500 is for including, in a case of displaying a list of gas facility operation data, information of the gas supply destination in the list, in a case where the list-of-overdue-operations display button 708, the list-of-scheduled-operations display button 709 or the like is input in the gas facility operation display interface 700.

Next, the communication unit 11 of the gas facility operation management server 1 transmits the gas facility operation data record acquired in step S803 and the gas supply destination data record acquired in step S804 to the mobile terminal 2, as gas facility operation data (step S805). In a case where the communication unit 11 of the mobile terminal 2 receives the gas facility operation data, the unit adds the number of records of the received gas facility operation data and displays the result in, for example, the number-of-scheduled-operations display field 706, and displays the gas facility operation data in the list-of-operations display field 707, in accordance with the condition designated by the list-of-scheduled-operations display button 709 or the like (step S806).

In the aforementioned manner, an operator can display, on the display unit 25 of the mobile terminal 2, the number and a list of gas facility operations whose state is uncompleted, for each day and/or for each class, with regard to the gas facility operations to be performed by the operator, and thus it becomes easy for the operator to manage the schedule or the like even in a case where there is a large number of facility operations to be performed by the operator himself or herself.

<Gas Facility Operation Data Update>

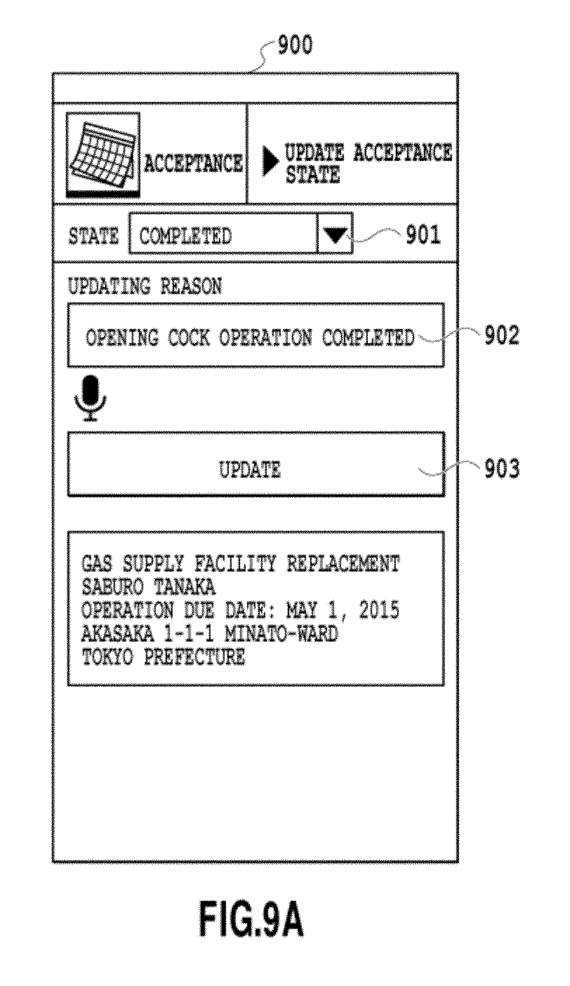

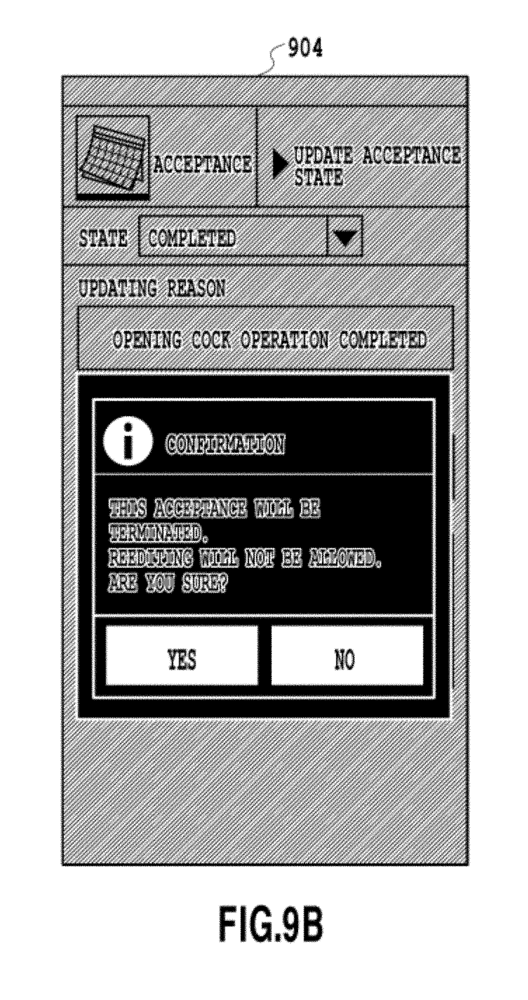

Next, a gas facility operation update interface 900 will be described with reference to FIGS. 9A and 9B. The gas facility operation update interface 900 is an interface screen which is displayed on the display unit 25 of the mobile terminal 2 and which is for updating a state of a gas facility operation to be performed by the operator. The gas facility operation update interface 900 may be displayed by selection of, for example, a target gas facility operation in the list-of-operations display field 707 in the gas facility operation display interface 700 (namely, transits between screens).

As illustrated in FIG. 9A, the gas facility operation update interface 900 has a state class selection field 901, an updating reason input field 902, and an update button 903. The state class selection field 901 has state classes such as “uncompleted”, “completed”, and “initial acceptance completed”, and these state classes are selectable in a form of a list box or the like.

In a case where an operator selects (selects to an updated value) a state class in the state class selection field 901, inputs an updating reason to the updating reason input field 902 (input to the updating reason input field 902 may be arbitrary), and presses down the update button 903, a confirmation-of-update indicator 904 is displayed (overlaid on the gas facility operation update interface 900), as illustrated in FIG. 9B. Selection of “yes” in such a state causes an message including these update values to be transmitted to the gas facility operation management server 1, and a relevant record of the gas facility operation data table 400 is updated. The updating prevents the updated gas facility operation data records from being added to the number of overdue operations and the number of scheduled operations, or the like, in the above-described gas facility operation display interface 700.

In the aforementioned manner, in a case where the updating reason for bringing the state into “completed”, defined for each acceptance type described in Table 1 is input, one event for the gas facility operation registered from the gas facility operation display/interface screen 300 is terminated. The input of the updating reason cannot necessarily be freely completed by the operator, and unless there is an input of an updating reason defined for each acceptance type, the input cannot be completed.

As described above, by controlling update of the state of the gas facility operation to be performed by the operator, it becomes possible to manage the state until the gas facility operation is completed, and is also possible to prevent omission of the operation. In addition, the screen of the gas facility operation update interface 900 transits from the gas facility operation display interface 700, and thus it becomes easy to specify the gas facility operation to be updated.

Note that execution propriety of updating the state class in the gas facility operation update interface 900 described above may be controlled on the basis of the business operator to which the operator belongs and the organization (office) of the gas supply company. Namely, execution of updating the state class may be controlled according to whether or not the operator belongs to the same business operator and/or office as the business operator and/or office to which the person-in-charge who has accepted the gas facility operation data to be updated belongs.

As an example of the foregoing, in a case where the office to which the person-in-charge who has accepted the gas facility operation data to be updated (input the gas facility operation data) belongs is different from the office to which a relevant operator belongs, the control may be carried out such that a press-down of the update button 903 causes an error. The control is executed, on the basis of respective items of “person-in-charge identification” and “operator identification” included in the gas facility operation data table 400, by acquiring both of employee data records from the employee data table 600, and by making a comparison between the values of the item “office identification” of respective records.

As described above, by controlling the update process of a state class of an operator, it is possible to avoid the operator's erroneous update of the state of a gas facility operation data that is outside administration of the operator.

Although a settlement method according to the present embodiment has been described above in detail, the specific data structures of the gas facility operation data table 400, the gas supply destination data table 500, and the employee data table 600 described in the embodiments, are merely exemplary and may be changed within a range not deviating from the accompanying claims. In addition, the order of steps in the flowchart described in FIG. 8 may be changed within a range not deviating from the accompanying claims, or some of the steps may be excluded.

1. A method implemented by a server computer connected to a client computer, the server computer including a data storage unit storing gas facility operation data including an acceptance classification, a state, a scheduled corresponding date, and an operator identification, for a gas facility operation, the method comprising the steps of:
causing a display unit of the client computer to perform display and generating an interface screen for accepting, from a user, a request message including an operator identification and a designated year and month, the interface screen including a first screen on which a date corresponding to the designated year and month is displayed in a calendar form, and a second screen on which the gas facility operation data is displayed;
receiving, from the client computer, a request message having been input from the interface screen;
acquiring, from the data storage unit, gas facility operation data indicating that the state is uncompleted, on the basis of the designated year and month and the operator identification;
calculating a number of the acquired gas facility operation data for each date corresponding to the designated year and month;
displaying the calculated number of gas facility operation data on the first screen; and
displaying the acquired gas facility operation data on the second screen.

2. The method according to claim 1, wherein the displayed gas facility operation data is displayed on the basis of the scheduled corresponding date and a current date.

3. The method according to claim 2, wherein the displayed gas facility operation data indicates that the scheduled corresponding date is earlier than the current date.

4. The method according to claim 1, wherein the displayed gas facility operation data indicates that the acceptance classification is urgently accepted.

5. The method according to claim 1, the interface screen further accepting, from the user, an update value for the acceptance classification, and
the method further comprising the steps of:
receiving, from the client computer, an update value having been input from the interface screen; and
updating, on the basis of the received update value, the gas facility operation data stored in a data storage unit.

6. The method according to claim 5,
the gas facility operation data stored in the data storage unit further including a person-in-charge identification of a person-in-charge who has created the gas facility operation data, and
the data storage unit further storing data including a first organization identification associated with the person-in-charge identification, and a second organization identification associated with the operator identification,
the method further comprising a step of acquiring, on the basis of the operator identification and the person-in-charge identification included in the acquired gas facility operation data, the first organization identification and the second organization identification from the data storage unit, wherein
the step of updating the gas facility operation data is controlled on the basis of the acquired first organization identification and the second organization identification.

7. A computer system connected to a client computer, the computer system comprising:
a data storage unit storing gas facility operation data including an acceptance classification, a state, a scheduled corresponding date, and an operator identification, for a gas facility operation;
a processor configured to:
cause a display unit of the client computer to perform display, and generating an interface screen for accepting, from a user, a request message including an operator identification and a designated year and month, the interface screen including a first screen on which a date corresponding to the designated year and month is displayed in a calendar form, and a second screen on which the gas facility operation data is displayed;
receive, from the client computer, a request message having been input from the interface screen;
acquire, from the data storage unit, gas facility operation data indicating that the state is uncompleted, on the basis of the designated year and month and the operator identification;
calculate the number of the acquired gas facility operation data records for each date corresponding to the designated year and month;
display the calculated number of gas facility operation data on the first screen; and
display the acquired gas facility operation data on the second screen.

8. (canceled)

9. A non-transitory computer-readable storage medium storing a program having a computer executable instruction, when executed by a computer, causing the computer to perform a method according to claim 1.
